(19) United States
(12) Patent Application Publication
(10) Pub. No.: US 2013/0126073 A1
(43) Pub. Date: May 23, 2013

(54) INTERNAL MOLD RELEASE

(71) Applicant: Apple Inc., Cupertino, CA (US)

(72) Inventor: Kevin M. Kenney, San Jose, CA (US)

(73) Assignee: Apple Inc., Cupertino, CA (US)

(21) Appl. No.: 13/626,552

(22) Filed: Sep. 25, 2012

Related U.S. Application Data
(60) Provisional application No. 61/561,566, filed on Nov. 18, 2011.

(51) Int. Cl. B05D 5/00; C08K 7/06; B29C 65/70; B05D 3/00; B29C 43/02; C08L 63/00; B05D 3/02

(52) U.S. Cl. 156/196; 523/468; 427/206; 264/299; 264/496; 427/374.1; 264/320

(57) ABSTRACT

A method of manufacturing a releasable composite prepreg for compression, sheet, or bulk molding. The method includes mixing together a resin and a curing agent, adding a release agent to the resin and curing agent creating a releasable epoxy, applying a backing to the releasable epoxy; and positioning a plurality of fibers within the releasable epoxy creating a releasable composite prepreg. The releasable composite prepreg created through the method can be molded to create components without requiring application of an external mold release agent.

### CROSS-REFERENCE TO RELATED APPLICATIONS

This application claims the benefit of U.S. Provisional Patent Application No. 61/561,566, filed Nov. 18, 2011 and titled “Internal Mold Release,” the disclosure of which is hereby incorporated herein in its entirety.

### TECHNICAL FIELD

The present invention relates generally to manufacturing components, and more specifically to manufacturing components utilizing composite materials.

### BACKGROUND

Molding may be used to form a variety of different components, objects and parts using a variety of materials. A typical molding process includes providing a mold shaped roughly or exactly as the desired shape of the object or the part. The mold is then filed with the desired material, which may generally be in a liquid, semi-liquid, or an otherwise moldable form. The material typically conforms to the mold, either initially or through the application of pressure. Heat and/or pressure is applied to cure the material within the mold. Due to the fact that the material conforms to the mold prior to being cured, the solidified material may be cured in the shape of the mold. This type of molding processes allow parts of many sizes and shapes to be created.

One drawback many molding manufacturing processes is that the components may adhere to the mold after they have solidified. This may present problems in removing the components from the mold. Components may break apart during removal, as some portions may adhere to the mold surface when the component is lifted off of the mold. In some instances, a mold release agent may be applied to the outer surface of the mold. Once the mold release agent is applied, the material may then be poured or otherwise applied to the mold. The mold release agent acts to lubricate the mold so that the material may not stick to the mold after it has finished curing or solidifying.

In some manufacturing processes, mold release agents must be reapplied between each component being manufactured. Thus, a typical process may require cleaning a particular mold or tool, applying a mold release agent, filing the mold with material, curing the material, and then removing the cured material. The steps of cleaning and reapplying the internal mold release agents may be time consuming and laborious.

Furthermore, mold releases may not always be effective. For example, if the mold has complicated geometry, such as sharp turns or corners, deep vertical walls, or minimal or zero draft angle, the material may still be difficult to remove from the mold as the mold release agent may not be adequately applied to the complicated geometry. Additionally, in some instances, the mold release agent may stick to the component, which may damage the cosmetic appearance of the component or may prevent or hinder paints, coatings, adhesives, and the like from adhering to the component. Furthermore, in some instances, the cosmetic appearance of the component may include discontinuities caused by the mold release agent during application or curing (e.g., runs from over-application of the mold release agent, streaks from wiping on mold release agent with a rag, or bubbles from out-gassing of the mold release agent).

### SUMMARY

Examples of embodiments described herein may take the form of a method for manufacturing a composite material. The method includes combining a release agent, a resin, and a curing agent to create a releasable epoxy. After the releasable epoxy has been created, adding reinforcing fibers, such as carbon or glass, to the releasable epoxy, creating a releasable composite.

Other embodiments may include a method of manufacturing a component for an electronic device. The method includes providing a releasable composite including a plurality of fibers impregnated with a releasable epoxy that includes a resin, a curing agent, and a release agent and applying the releasable composite to a mold in the form of the component. Once the releasable composite has been applied to the mold, curing the releasable composite. When the releasable composite has cured, removing the cured releasable composite from the mold.

Yet other embodiments include a method for manufacturing a releasable composite. The method includes combining a resin and a hardener, combining a release agent with the resin and the hardener creating a releasable epoxy, wherein the release agent has a concentration between 1 and 10 percent of a total volume of the releasable epoxy, positioning a plurality of carbon fibers in the releasable epoxy, creating a releasable composite prepreg, heating the releasable composite prepreg, and cooling the releasable composite prepreg to prevent complete polymerization of the resin.

In one example of the method for creating the releasable composite, the carbon fibers are arranged in a substantially unidirectional manner within the releasable epoxy.

In yet another example of the method for creating the releasable composite, positioning the plurality of carbon fibers in the releasable epoxy includes dipping the carbon fibers into the releasable epoxy.

In some examples of the method for creating the releasable composite, the resin is a epoxide and the hardener is polyamine.

Still other embodiments include a method for manufacturing a releasable composite prepreg. The method includes combining a resin and a hardener, combining a release agent with the resin and the hardener creating a releasable epoxy, wherein the release agent has a concentration between 1 to 10 percent of a total volume of the releasable epoxy, combining a plurality of carbon fibers with the releasable epoxy. In these embodiments, the releasable epoxy may be advanced, partially cured, or “B” staged to produce prepreg, such as by heading the releasable composite prepreg and then cooling the releasable composite prepreg to prevent complete polymerization of the resin. Retarders may also be used to modify the chemistry of the resin in such a way so that full polymerization will not occur (or may occur very slowly, over months or longer) in a low temperature environment.

### BRIEF DESCRIPTION OF THE DRAWINGS

FIG. 1 is a flow chart illustrating a method of manufacturing a component using conventional composite material.

FIG. 2 is a perspective view of an electronic device including an enclosure or component created from a releasable composite.

FIG. 3 is a cross-section view of the enclosure taken along line 3-3 in FIG. 2.

FIG. 4 is a flow chart illustrating a method for creating a releasable composite “prepreg” or pre-impregnated composite material.

FIG. 5 is a side elevation view of a releasable epoxy applied to a backing.

FIG. 6 is a flow chart illustrating a method for manufacturing a component using the releasable composite.

FIG. 7 is a diagram illustrating the releasable composite positioned within a mold.

### DETAILED DESCRIPTION

This disclosure relates generally to composite materials and methods of manufacturing components utilizing composite materials. Composite materials, as referred to herein, include an epoxy or resin having reinforcing fibers such as glass or carbon (one example of which is carbon reinforced epoxy). However, other reinforcing fibers may also be used, such as, but not limited to, aramid, polyethylene, polypropylene, quartz, and ceramic. Additionally, other possible matrix materials such as polyester, vinyl-ester, cyanate, ester, or the like may be used. It should be noted that although the discussion herein is related to creating a prepreg composite material, other composite materials may also be created using similar processes to those disclosed herein. As some non-limiting examples, the methods described herein may be used to create a compression molding compound (chopped prepreg), a sheet molding compound, and/or a bulk molding compound. Examples of using the methods herein for creating alterative composite materials are discussed in more detail below.

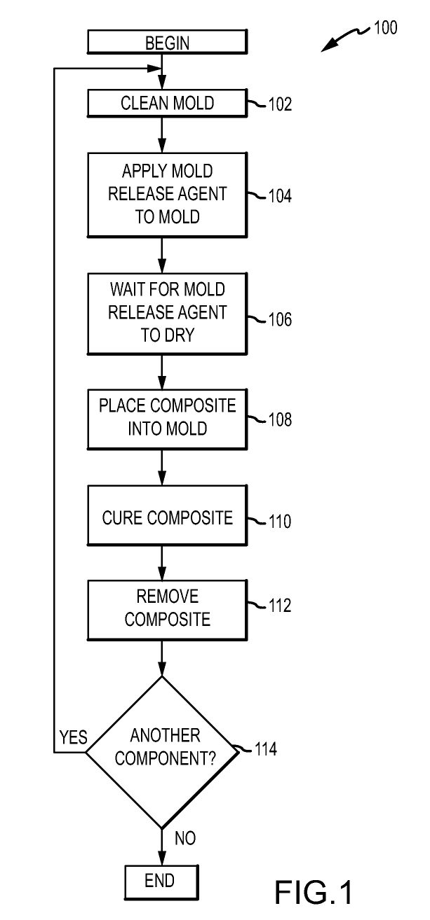

FIG. 1 is a flow chart illustrating a method of manufacturing components using typical composite materials, such as carbon fiber reinforced plastic (CFRP) prepreg. The method 100 begins with operation 104, in which a mold or other tooling for creating the component or part is cleaned. As described briefly above in the background section, during many compression molding or other molding processes, the molded material may stick to the mold, leaving pieces attached after the component is removed. Also, often an external mold release agent may be applied to the mold or tooling prior to composite being added. Accordingly, prior to a new component being created, the mold may typically need to be cleaned in order to remove remnants of the external mold release agent or prior molded component. For example, chemicals may be sprayed into the mold to remove the mold release agent. Other examples for cleaning the mold may include heating the mold sufficiently above the operating temperature of the resin to “burn off” any residue, as well as using ultrasonic tank cleaning techniques that induce agitation into a liquid solution to remove any remaining portions of the composite.

After the mold is cleaned, the method 100 proceeds to operation 104 and the mold release agent is applied to the mold. The manner in which the mold release agent is applied depends on the type of mold release agent used. For example, the mold release agent may be sprayed, painted, or wiped on with a rag or other cloth material. Once the mold release agent is applied, the method 100 may proceed to operation 106 and the method 100 may pause. Often, mold release agents may need to dry adequately prior to a composite being added, therefore before a component may be created, the method 100 pauses for a waiting period. During the waiting period, the mold release agent is given time to dry after being applied. If the composite is added too soon after the mold release agent has been applied, the mold release agent may not be as effective and the composite could stick to the mold. Alternatively or additionally, the mold release agent may cause discontinuities as it pools prior to drying and the composite is added on top of the pools. The drying wait time depends on the mold release agent used, and can range from two minutes to an hour or more. Again, the wait time depends on the type of mold release agent chosen. Furthermore, in some cases multiple layers of mold release are required, with some dry time required between each layer.

Once the mold release agent is dry, the method 100 may then proceed to operation 108 and the composite may be positioned within the mold. For example, if the composite is carbon/epoxy prepreg, the layers of prepreg are placed into the mold until the desired thickness is reached. Once the composite is applied, the method 100 proceeds to operation 110 and the composite is cured. Curing the composite may involve applying heat, pressure, and/or a chemical process. In one example, pressure and heat may be provided by the mold, e.g., a pressure molding tool.

Once the composite 100 is cured, the method 100 may proceed to operation 112 and the composite may be removed from the mold. Depending on the curing process and mold, the mold may be opened after it has cooled to remove the component. Further, depending on the success of the mold release agent, the composite may be removed without substantial damage to the component. However, as discussed above, in some instances, the component may be damaged either physically and/or cosmetically during removal. Once the component has be removed, the method 100 may proceed to operation 114 and it may be determined whether another component is to be created. If another component is going to be created, the method 100 returns to operation 102 and the mold is cleaned. However, if the another component is not going to be created, the method 100 ends.

Now, a releasable composite will be discussed in more detail. The releasable composite may reduce manufacturing time as well as costs as compared to conventional composite materials and manufacturing processes. This is because the releasable composite may eliminate or reduce the need for external mold release agents. In one embodiment, the releasable composite may be created by combining a release agent with a base material, such as epoxy, to create a releasable epoxy. The releasable epoxy may then be combined with fibers (e.g., carbon or glass) to create the releasable composite. As described in more detail below, the releasable composite may be used in instances where a prepreg material is desired, or in other instances where other types of composite materials may be desired (such as, but not limited to, compression molding compounds, sheet molding compounds, and/or bulk molding compounds).

The releasable composite may be applied to or positioned within a mold or tooling apparatus and cured. Once cured, the releasable composite may form a component generally matching the shape of the mold. Additionally, due to the internal release agent, the epoxy and fibers may be prevented from adhering to the mold after curing. Thus, the cured releasable composite may be removed from the mold without substantially damaging the created component. Manufacturing processes for various components created with the releasable composite, e.g., housing enclosures, internal electronic parts, and so on, may therefore be more efficient as fewer components may be damaged while being removed from the mold.

Further, manufactured components made from the releasable composite material may have an improved cosmetic appearance compared to traditionally molded composites. As the releasable composite eliminates the need for an external mold release to be applied to the mold, the end product or cured composite may include a substantially smooth or shiny surface substantially free from unwanted discontinuities or bumps that can be created by an external mold release agent, e.g., due to bubbles, pooling, and so on.

Moreover, manufacturing processes utilizing the releasable composite can cure multiple components in succession without applying an external mold release between each part. This reduces the manufacturing time for each component. The labor costs associated with cleaning the mold and reapplying a mold release agent to the mold may also be reduced. Further, some external mold release agents may require drying time after being applied; thus, using the releasable composite may further decrease manufacturing time.

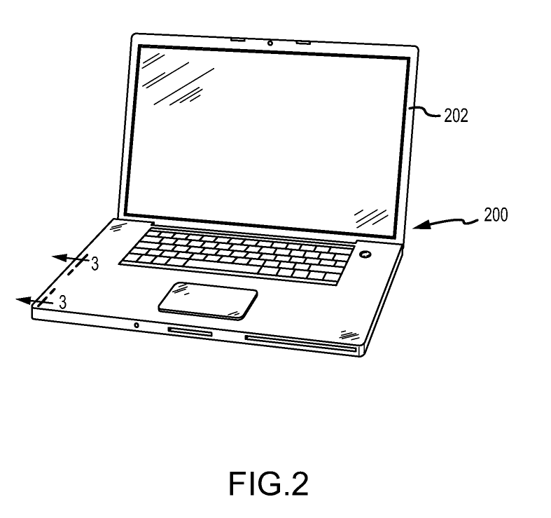

As briefly stated above, the releasable composite may be molded and cured to create various components or parts. In some embodiments, the releasable composite may be used in consumer electronic products (e.g., enclosures, housing, internal parts), automobile or manufacturing parts, aerospace components, athletic equipment, and so on. FIG. 2 is a perspective view of an electronic device 200 including an enclosure or housing 202 formed of a releasable composite. It should be noted that FIG. 2 is an example of a component that may be created with the releasable composite, and many other various components and parts are possible. The shape and size of the component created may be varied by varying the shape and size of the mold; therefore, substantially any type of component may be created using the releasable composite.

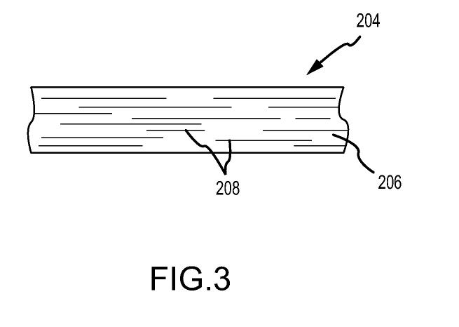

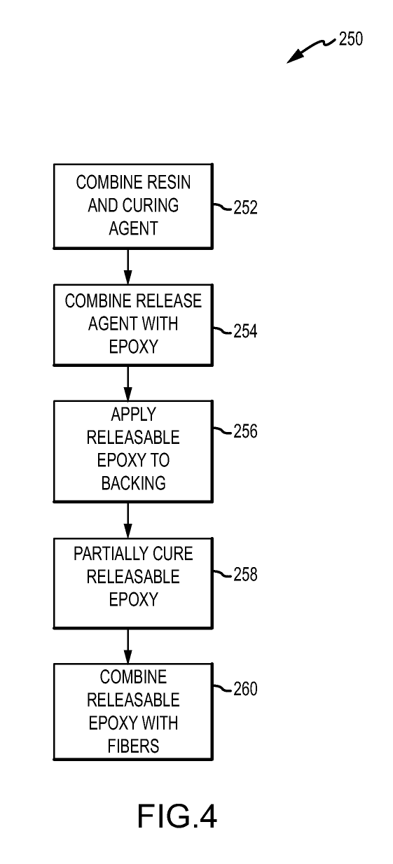

The releasable composite for creating the component will now be discussed in more detail. FIG. 3 is a cross-sectional view of the enclosure 202 taken along line 3-3 illustrating the releasable composite 204. The releasable composite 204 may include a releasable epoxy 206 having fibers 208 dispersed throughout. The composition of the releasable epoxy 206 will be discussed in more detail with respect to FIG. 4. The enclosure 202 or other components created using the releasable composite 204 may include one or more layers of the releasable composite 204 that may be cured together to form a single structure. Thus, the thickness of a manufactured component, such as the enclosure 202, may be varied by varying the layers of the releasable composite that are cured together. In some instances, portions or pieces of the releasable composite may be cured together rather than in discrete layers. For example, the releasable composite may be cut into smaller pieces and the pieces may be combined into a mold and then cured together, rather than having separate layers of the composite. The type of arrangement within the molding may depend on the type of fibers used, as well as the shape of the mold, and/or type of component desired to be manufactured with the releasable composite.

Each layer of the releasable composite 204 includes the releasable epoxy 206, resin, or other moldable material. The fibers 208 may be positioned within the releasable epoxy 206 in substantially any manner. However, in some embodiments, the fibers 208 for each layer of the releasable composite 204 may be aligned in the same direction, that is, they fibers 208 may be unidirectional. In other embodiments, the fibers 208 may be positioned in various directions or weaved together. Further, the fibers 208 may be substantially continuous or discontinuous within the releasable epoxy 206. For example, in some instances (e.g., sheet molding compounds or bulk molding compounds) the fibers 208 may be chopped or otherwise used as small pieces that are positioned within the releasable epoxy 206.

The fibers 208 may be substantially any type of material that provides reinforcing strength to the releasable epoxy 206. For example, the fibers 208 may be carbon, glass, aramid, polyethylene, polypropylene, quartz, or ceramic.

The composition of the releasable epoxy 206 and a process to create the releasable composite 204 using the releasable epoxy 206 will now be discussed in more detail. FIG. 4 is a flow diagram illustrating a method for creating the releasable composite prepreg 204. The method 250 may begin with operation 252 and a resin (e.g., epoxide) and a curing agent such as a hardener or activator (e.g., polyamine) may be combined to create an epoxy or polyepoxide. It should be noted that, although the epoxy is discussed as being the base layer for the releasable composite, in some embodiments a resin other than epoxy may be used. For example, polyurethanes, phenolic and/or amino resins, or bismaleimides may be used as well. Additionally, in some instances, the resin may be a ultra-violet curable (UV) or light activated. In these instances, the resin may cure relatively quickly when exposed to a light, such as a UV light. In some examples, UV curable resins may cure faster than thermally cured resins and so may increase efficiency in manufacturing, especially in mass production manufacturing.

Once or as the epoxy is created in operation 252, the method 250 may proceed to operation 254 and a release agent may be combined with the epoxy. As the release agent is combined with the epoxy, the epoxy transitions to form the releasable epoxy 206. The release agent may be a lubricant, slip agent, or the like. For example, the release agent may include polytetrafluoroethylene particles, polyvinyl alcohol, and so on. However, many other suitable compounds and chemical compositions could be used as the release agent. As an example, other compounds or chemical compositions that provide a lubricating or slip agent function could be used, and thus the disclosure is not limited to any particular compound or chemical described herein. The release agent reduces the “tackiness” or adhesion properties for the releasable epoxy 206 once the epoxy 206 is cured.

The release agent may be combined in various amounts, depending on the desired final characteristics of the manufactured component. For example, as the concentration of the release agent increases, the cured releasable composite 204 will better release from the mold. However, increasing the concentration of the release agent may result in a degradation in post processing of the component. For example, if the component is going to be painted, bonded or adhered to another part, the release agent may degrade the bond between the paint, adhesive, or the like and the component. Therefore, for components that may not be bonded, painted, or adhered, the release agent concentration may be high, whereas for components that may be bonded, painted or adhered, the concentration may be lower. In some embodiments, the release agent may have a concentration between 0.5 to 10 percent of the total volume of the releasable epoxy 206. Specifically, the concentration of the release agent may range between 1 and 2 percent of the releasable epoxy in some embodiments. In others, the release agent may be up to 5 to 6 percent of the releasable epoxy, by concentration.

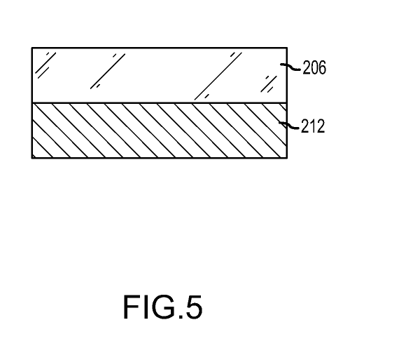

After operation 254, the method 250 may proceed to operation 256 and the releasable epoxy 206 may be applied onto a carrier or backing 212, creating an epoxy film. FIG. 5 is a side elevation view of the releasable epoxy 206 positioned on a backing 212. The backing 212 may be a paper backing, or other material that remains in contact with the releasable epoxy 206, but does not permanently adhere to it.

The method 250 may then proceed to operation 258 and the releasable epoxy 206 may be partially cured or “B staged.” For example, the releasable epoxy 206 may be heated to cure the resin for a short period of time and then cooled or quenched in order to prevent complete polymerization of the resin. In other words, releasable epoxy 206 will only be partially cured, so that it can be completely cured during the actual molding process. In another examples, the releasable epoxy 206 may be partially cured chemically or through exposure to UV light. In these examples, the releasable epoxy 206 may not need to be heated in order to cure, but may be exposed light, such as UV light, or another element that may cause a chemical reaction to allow the resin to partially cure.

By partially curing the releasable epoxy 206 in operation 258, the releasable epoxy 206 may be more easily stored and transported. The releasable epoxy 206 may be tacky and may stick to itself as well as to other objects. Partially curing the releasable epoxy 206 reduces some of the tackiness as well as provides some cohesiveness. Accordingly, the backing 212 plus the additional cohesiveness allows the releasable epoxy 206 to be more easily stored. For example, once the releasable epoxy 206 is placed on the backing 212 and partially cured, it may be wound around itself and stored on a roller, mandrel or the like.

After operation 258, the method 250 may proceed to operation 260 and the releasable epoxy 206 may be combined with the fibers 208. This impregnates the fibers 208 with the releasable epoxy 206 prior to full or final curing. In other words, the fibers 208 and the releasable epoxy 206 form “prepreg.” The fibers 208 may be combined with the releasable epoxy 206 in various manners. In some embodiments, the fibers 208 may be pressed (e.g., via rollers) into the releasable epoxy 206. However, other methods for combining the fibers 208 with the releasable epoxy 206 are also envisioned.

It should be noted that although the method 250 as shown in FIG. 4 includes operations 256 and 258 preceding operation 260, other methods are possible. For example, in some embodiments, the fibers 280 may be dipped into the releasable epoxy 206 and the releasable composite may then be rolled into a film and applied to the backing 212. Similarly, in other embodiments, the fibers 280 may be formed as a film and the releasable epoxy 206 may be laid out or hand-applied to a surface of the fibers 208.

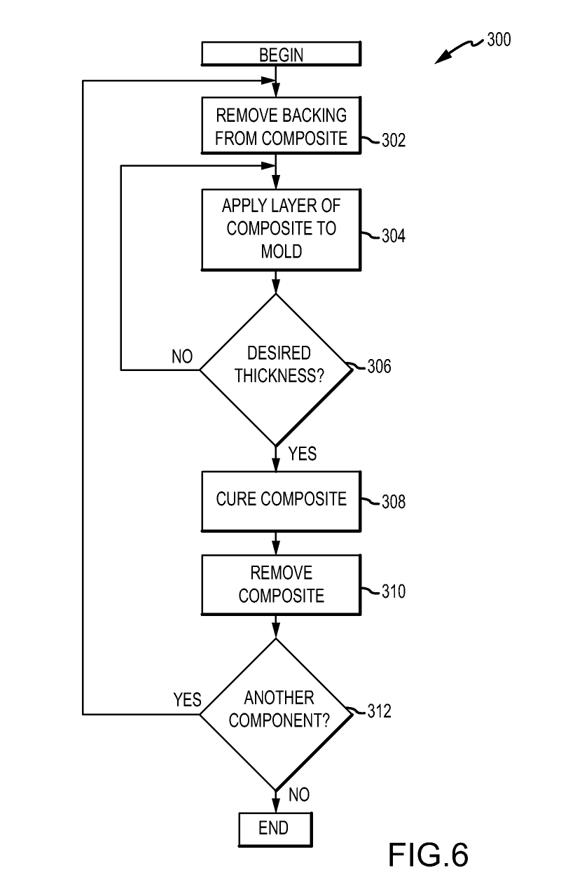

Once the releasable composite 204 has been created it may be used to create various components, such as the electronic device 100 in FIG. 1. One method of manufacturing components using the releasable composite 204 will now be discussed in more detail. FIG. 6 is a flow chart illustrating a method 300 for manufacturing components. The method 300 may begin with operation 302 and the releasable composite 204 may separated from the backing 212. As described above with respect to FIG. 5, the backing 212 may be applied to the releasable composite 204 when it is still an epoxy to provide better handling and storage. Prior to curing the releasable composite 204, the backing 212 may be removed either manually by an operator or automatically by a take-up roller driven by a motor. An example of a take-up roller for removing a backing for prepreg material is provided in U.S. patent application Ser. No. 13/039,490, entitled “Composite Enclosure,” which is hereby incorporated by reference in its entirety.

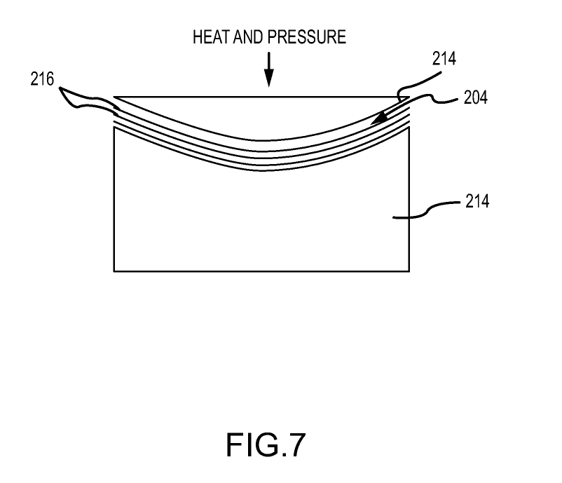

Once the backing 212 has been removed, the method 300 may proceed to operation 304 and a layer of the releasable composite 204 may be applied to a mold. FIG. 7 is a side elevation view of a mold 214 including multiple layers 216 of the releasable composite 204. The releasable composite 204 may be positioned within the mold 214 in a variety of manners, but generally may be positioned so as to be encompassed and at least partially enclosed within the mold 214. In some embodiments, the releasable composite 204 may be shaped to better fit into the mold 214, e.g., by cutting the releasable composite 204. Additionally, in some instances, the releasable epoxy may be positioned within the mold in pieces or portions, rather than being positioned in discrete layers.

After a layer of releasable composite 204 is positioned within the mold 214, the method 300 may proceed to operation 306. In operation 306 a user or a computer may determine whether the desired thickness for the component has been reached. The layers 216 of releasable composite 204 may be combined together (during the curing process) to form the overall thickness of the manufactured component. Therefore, the number of layers 216 determines the thickness. Accordingly, if the desired thickness has not yet been achieved, the method 300 may return to operation 304 and additional layers of releasable composite 204 may be positioned on the previously deposited layers 216. These operations 304, 306 may be repeated until the desired thickness has been reached.

Once the desired thickness has been reached, the method 300 may proceed to operation 308. In operation 308 the releasable composite 204 may be cured. The curing process may depend on the type of resin and curing agents used in the releasable epoxy 206. However, with reference to FIG. 7, in one embodiment, heat and pressure may be used to cure the releasable composite 204. The heat and pressure are applied while the releasable composite 204 is positioned within the mold 214. The heat and pressure cause the curing agent to fully cure the resin, and thus harden the epoxy 206 around the fibers 208. Additionally, during the curing process the various layers 216 may combine to form a single integrated structure. In other embodiments, the releasable composite 204 may be cured via other mechanisms, e.g., a chemical reaction, heat or pressure alone, UV light exposure, and so on.

After the releasable composite 204 has been cured, the method 300 proceeds to operation 310 and the releasable composite 204 is removed from the mold 214. Due to the release agent being mixed into the releasable composite 204, the releasable composite 204 may be easily removed from the mold 214. Additionally, the release agent may substantially prevent the releasable composite 204 from sticking or adhering to the mold 214. Thus, the risk that the cured releasable composite 204 may be damaged while removing it from the mold 214 is reduced as compared to conventional composites.

Once the releasable composite 204 has been removed from the mold 214, the method 300 may proceed to operation 312. In operation 312 a user or computer may determine whether another component is desired. If another component is desired, the method 300 may return to operation 302. It should be noted that due to the release agent within the releasable composite 204, the method 300 may begin to create another part without cleaning the mold 214 or applying an external release agent. Thus, the method 300 may be used to manufacture multiple components in succession without requiring time between each component to clean the mold 214 and/or apply an external mold release.

Furthermore, the components having the releasable composite 204 and created using the method 300 may have an improved cosmetic outer surface compared with conventional composite components. As described above, conventional composites, such as CFRP typically require a mold release agent to be applied to the mold prior to curing. The mold release agent may cause bubbles, unsmooth surfaces, and/or discontinuities in the final cured component as the mold release agent may condensate, form pools, runs, or the like on the surface of the mold. Furthermore, often mold release agents may not be effective, especially after a couple of parts, and so the curved composite may be broken, scratched, or the like when removed from the mold. On the contrary, the releasable composite may be cured and removed from a mold without requiring an external mold release agent, and may therefore avoid the issues caused therefrom. For instance, components created with the releasable composite may have smooth surfaces that may be relatively free from discontinuities, as well as may be formed in complex shapes.

It should be noted that the method described in FIG. 6 may be varied depending on the desired components or the type of releasable composite that may be used. As an example, in instances where a compression molding compound is used, the releasable composite may be cut in a variety of pieces that may be heated and pressed within the mold, rather than be positioned in discrete layers. Accordingly, the discussion of any particular embodiment is meant as illustrative only.

The methods of FIGS. 5 and 6 may be used to create a number of different components, such as components for computing devices, aerospace and/or automobile technologies. Accordingly, the discussion of any particular end product for the releasable composite 204 is not meant as limiting, but as illustrative only. Furthermore, although the discussion of the releasable composite 204 is directed to “prepreg” composite materials, other materials may be manufactured in a similar manner to reduce the need for an external mold release. As one example, the releasable composite 204 and the method of FIGS. 5 may be used to create a compression molding compound, which may include relatively small chips of fibers 208 and resin or epoxy 206. The pieces of fibers and resin may be heated and may then be pressed or otherwise formed into a particular component. In this example, as some non-limiting examples, the releasable epoxy may be used to create components for automotive and/or aerospace industries.

As another example, the method of FIG. 5 may be used to make a sheet molding compound. In this example, the fibers 208 may be positioned as small pieces within the releasable epoxy 206, e.g., as chopped portions and not continuous fibers. In this example, as some non-limiting examples, the releasable composite maybe used to create the body panels, hoods, and/or bumpers for automobiles.

As yet another example, the method of FIG. 5 may be used to create a bulk molding compound. In this example, the fibers 208 may have a shorter length as compared to embodiments where a prepreg is desired. Additionally, as compared to the prepreg examples, the concentration of the fibers 208 to the releasable epoxy 206 may be reduced, which may reduce the structural strength of the releasable composite, but allow the releasable composite to be more flexible. In these instances, the releasable composite may be used to create components that may require less structure strength, such as headlight housings for automobiles, or electrical components where the epoxy 206 may include a dielectric resin.

Conclusion

The foregoing description has broad application. For example, while examples disclosed herein may focus on creating composite structures for electronic devices, it should be appreciated that the concepts disclosed herein may equally apply to composites used in other applications, such as sporting equipment, automobiles, sailing vessels, and so on. Similarly, although the composite techniques may be discussed with respect to CFRP, the techniques disclosed herein are equally applicable to other fiber matrix materials. Accordingly, the discussion of any embodiment is meant only to be an example and is not intended to suggest that the scope of the disclosure, including the claims, is limited to these examples.

What is claimed is:

1. A method of manufacturing a releasable composite prepreg for compression molding comprising:
mixing together a resin and a curing agent;
adding a release agent to the resin and curing agent creating a releasable epoxy;
applying a backing to the releasable epoxy; and
positioning a plurality of fibers within the releasable epoxy creating a releasable composite prepreg.

2. The method of manufacturing of claim 1, wherein the plurality of fibers are one of carbon or glass.

3. The method of manufacturing of claim 1, wherein the release agent has a concentration ranging between 1 to 10 percent.

4. The method of manufacturing of claim 3, wherein the release agent has a concentration between 1 and 3 percent.

5. The method of manufacturing of claim 1, wherein the plurality of fibers are positioned within the releasable epoxy by pressing the plurality of fibers into the releasable epoxy.

6. The method of manufacturing of claim 1, wherein the plurality of fibers are dipped into the releasable epoxy, prior to applying a backing to the releasable epoxy, wherein the dipping of the plurality of fibers positions the plurality of fibers within the releasable epoxy.

7. The method of manufacturing of claim 1, wherein the resin is a ultraviolet light curing resin or a thermally curable resin.

8. A method of manufacturing a component for an electronic device comprising:
providing a releasable composite including a plurality of fibers impregnated with a releasable epoxy that includes a resin, a curing agent, and a release agent;
applying the releasable composite to a mold in the form of the component;
curing the releasable composite; and
removing the cured releasable composite from the mold.

9. The method of manufacturing of claim 8, wherein curing the releasable composite comprises applying heat and/or pressure to the releasable composite.

10. The method of manufacturing of claim 8, wherein curing the releasable composite comprises applying ultra violet light to the releasable composite.

11. The method of manufacturing of claim 8, wherein when the cured releasable composite is removed from the mold, applying more releasable composite to create a second component without applying an external mold release agent to the mold.

12. The method of manufacturing of claim 8, wherein applying the releasable composite to the mold comprises applying one or more layers of the releasable composite to the mold until a desired thickness is achieved.

13. The method of manufacturing of claim 8, wherein the release agent has a concentration between 0.5 to 3 percent of the volume of the releasable epoxy.

14. The method of manufacturing of claim 9, wherein the plurality of fibers are unidirectional.

15. The method of manufacturing of claim 6, wherein the plurality of fibers are one of carbon or glass.

16. A method for manufacturing a releasable composite comprising:
combining a resin and a hardener;
combining a release agent with the resin and the hardener creating a releasable epoxy, wherein the release agent has a concentration between 1 and 10 percent of a total volume of the releasable epoxy;
positioning a plurality of carbon fibers in the releasable epoxy, creating a releasable composite prepreg;
heating the releasable composite prepreg; and
cooling the releasable composite prepreg to prevent complete polymerization of the resin; wherein
the carbon fibers are arranged in a substantially unidirectional manner within the releasable epoxy.

17. The method of manufacturing of claim 16, wherein positioning the plurality of carbon fibers in the releasable epoxy comprises dipping the carbon fibers into the releasable epoxy.

18. The method of manufacturing of claim 16, wherein the resin is a epoxide and the hardener is polyamine.

19. The method of manufacturing of claim 16, wherein the releasable composite is configured to be used as an enclosure for an electronic device.

20. The method of manufacturing of claim 16, further comprising prior to heating the releasable composite prepreg, positioning a paper backing on the releasable epoxy.
